(19) United States
(12) Patent Application Publication
(10) Pub. No.: US 2020/0302502 A1
(43) Pub. Date: Sep. 24, 2020

(54) COMMODITY INFORMATION INSPECTION SYSTEM AND CONTROL METHOD FOR COMPUTER

(71) Applicant: Ishida Co., Ltd., Kyoto (JP)

(72) Inventors: Shun SATO, Ritto-shi (JP); Yuji NAKAGAWA, Ritto-shi (JP)

(73) Assignee: Ishida Co., Ltd., Kyoto (JP)

(21) Appl. No.: 16/821,758

(22) Filed: Mar. 17, 2020

(30) Foreign Application Priority Data
Mar. 20, 2019 (JP) 2019-053190

(51) Int. Cl. G06Q 30/06

(52) U.S. Cl. CPC G06Q 30/0623

(57) ABSTRACT

A commodity information inspection system includes: a storage unit; an identification information specification unit; an image information acquisition unit configured to acquire image information related to the commodity label; a first extraction unit configured to extract, as text information from the storage unit, a predetermined commodity item to be a comparison target in the commodity information that is stored in association with the identification information that is specified by the identification information specification unit; a second extraction unit configured to extract, as text information, information of characters included in the image information acquired by the image information acquisition unit; and a determination unit configured to determine whether the commodity label and/or the wrapping material is correct based on a comparison between a character string as text information extracted by the first extraction unit and a character string as text information extracted by the second extraction unit.

### TECHNICAL FIELD

An aspect of the present disclosure relates to a commodity information inspection system and a control method for a computer.

### BACKGROUND

For example, a commodity label on which a trade name, an expiration date, raw materials, and the like are written is attached to a commodity such as bread and a rice ball. In factories and the like for manufacturing such commodities, an inspection is conducted to find whether a commodity label to be attached to a manufactured commodity is correct as a label that should be attached to the commodity. As such a method of inspecting whether the label is correct, there is known an inspection method using a label register including a portion in which information related to a commodity (for example, a trade name) is printed, a portion in which a correct commodity label (hereinafter, referred to as a “sample label”) that should be attached to the commodity is printed (or attached), and a portion in which a commodity label to be attached (hereinafter, referred to as a “label planned to be attached”) is attached. An operator checks whether the sample label matches the label planned to be attached by visual inspection. There may be a case of using a label register in which only character strings of commodity information that should be checked (a trade name, a price, a consume-by date, a character string related to a bar code, a name of a production plant, an identification code for a production line, an identification code for delivery, and the like) are printed (or attached) without using a sample label.

Patent Literature 1 (Japanese Unexamined Patent Publication No. 2016-1503) discloses a label register inspecting device for automatically conducting such inspection by visual inspection. Specifically, disclosed is the label register inspecting device configured to determine whether the label planned to be attached is correct (whether the sample label matches the label planned to be attached) by imaging a sample label and a label planned to be attached with an imaging device, and comparing a taken image of the sample label with a taken image of the label planned to be attached.

### SUMMARY

However, in the conventional method described above, to conduct comparison inspection, it is required to replace the sample label, which is the commodity label to be attached, in a case in which the design of the commodity label (for example, character position, character size, background image, coloring and the like) is changed, even when the commodity information such as a trade name is not changed, for example, and this work requires much time and effort. Wrapping materials for wrapping the commodity present the same problem as that of the commodity label.

Thus, according to one aspect of the present disclosure, there is provided a commodity information inspection system and a control method for a computer that makes it possible to determine whether a commodity label and/or a wrapping material is correct without time and effort for work accompanying change even when the design of the commodity label and/or the wrapping material is changed.

A commodity information inspection system according to an aspect of the present disclosure is a commodity information inspection system configured to determine whether a commodity label to be attached to a commodity and/or a wrapping material for wrapping the commodity is correct one corresponding to the commodity, and includes: a storage unit configured to store identification information for identifying the commodity, and commodity information related to the commodity, and to associate the identification information and the commodity information with each other; an identification information specification unit configured to specify identification information of the commodity related to production; an image information acquisition unit configured to acquire image information related to the commodity label to be attached to the commodity and/or the wrapping material for wrapping the commodity on which one or more commodity items included in the commodity information are printed; a first extraction unit configured to extract, as text information from the storage unit, a predetermined commodity item to be a comparison target in the commodity information that is stored in association with the identification information that is specified by the identification information specification unit; a second extraction unit configured to extract, as text information, information of characters included in the image information acquired by the image information acquisition unit; and a determination unit configured to determine whether the commodity label and/or the wrapping material is correct based on a comparison between a character string as text information extracted by the first extraction unit and a character string as text information extracted by the second extraction unit.

In the commodity information inspection system having the configuration described above, whether the commodity label and/or the wrapping material is correct is determined by comparing the commodity item as text information stored in the storage unit with the commodity item as the text information extracted from the image information instead of comparing the image information of the commodity label to be a sample (to be attached) and/or the wrapping material with the image information of the commodity label to be attached to the commodity and/or the wrapping material acquired by the image information acquisition unit. That is, in the commodity information inspection system having this configuration, reference data for determining whether the commodity label and/or the wrapping material is correct is not image information but text information. As a result, even in a case in which the design of the commodity label and/or the wrapping material is changed, whether the commodity label and/or the wrapping material is correct can be determined without time and effort for work accompanying the change.

In the commodity information inspection system according to one aspect of the present disclosure, the first extraction unit may extract a trade name as the commodity item. In this configuration, a character string of the trade name can be used as the reference data for determining whether the commodity label and/or the wrapping material is correct.

The commodity information inspection system according to one aspect of the present disclosure further includes: a third extraction unit configured to extract, from the storage unit, a trade name that includes the entire character string included in the trade name extracted by the first extraction unit and is associated with other identification information different from the identification information specified by the identification information specification unit, wherein the determination unit may determine that the commodity label and/or the wrapping material is not correct in a case in which the character string of the trade name extracted by the third extraction unit is included in the character string of the trade name extracted by the second extraction unit.

Exemplified is a case in which there are “curry bun” and “hot curry bun” as trade names stored in the storage unit, the character string acquired by the first extraction unit is “curry bun”, and the character string acquired by the second extraction unit is “hot curry bun”. In this case, the character string “curry bun” acquired by the first extraction unit is different from the character string “hot curry bun” acquired by the second extraction unit, so the determination unit should determine that the commodity label and/or the wrapping material is not correct. However, the determination unit determines that the commodity label and/or the wrapping material on which “hot curry bun” is printed, which is acquired by the image information acquisition unit, is a correct commodity label and/or the wrapping material because the character string “curry bun” extracted by the first extraction unit is included in the character string “hot curry bun” acquired by the second extraction unit. In this way, in a case in which there are a plurality of similar trade names in the storage unit, the accuracy of the determination unit in determining correctness may decline.

Thus, in a configuration according to one aspect of the present disclosure, the third extraction unit extracts the trade name including the entire character string included in the trade name extracted by the first extraction unit to extract a trade name similar to the trade name extracted by the first extraction unit. In a case in which the trade name extracted by the third extraction unit is included in the trade name extracted by the second extraction unit, it is determined that the commodity label acquired by the image information acquisition unit is not correct. That is, when the character string “hot curry bun” extracted by the third extraction unit is included in the character string “hot curry bun” extracted by the second extraction unit, the determination unit can determine that the commodity label acquired by the image information acquisition unit is not correct. Due to this, even in a case in which there are a plurality of similar trade names in the storage unit, the accuracy of the determination unit in determining correctness can be improved.

The commodity information inspection system according to one aspect of the present disclosure further includes a third extraction unit configured to extract, from the storage unit, a trade name having an edit distance equal to or smaller than a predetermined value with respect to the character string of the trade name extracted by the first extraction unit, the trade name being associated with other identification information different from the identification information specified by the identification information specification unit, wherein the determination unit may determine that the commodity label and/or the wrapping material is not correct in a case in which the character string of the trade name extracted by the third extraction unit is included in the character string of the trade name extracted by the second extraction unit.

The known definition of the edit distance mentioned here is an indicator indicating a degree of difference between two character strings, and it is also called a Levenshtein distance. Exemplified is a case in which there are “curry bun” and “hot curry bun” as the trade names stored in the storage unit, the character string acquired by the first extraction unit is “curry bun”, and the character string acquired by the second extraction unit is “hot curry bun”. In this case, the determination unit should determine that the commodity label planned to be attached is not correct because the character string acquired by the first extraction unit is different from the character string acquired by the second extraction unit. However, the character string “curry bun” extracted by the first extraction unit is included in the character string acquired by the second extraction unit, so that the determination unit determines the commodity label on which “hot curry bun” is printed that is acquired by the image information acquisition unit to be a correct commodity label. In this way, in a case in which there are a plurality of similar trade names in the storage unit, the accuracy of the determination unit in determining correctness may decline.

Thus, in a configuration according to one aspect of the present disclosure, the third extraction unit extracts the trade name including the character string having the edit distance equal to or smaller than the predetermined value with respect to the character string of the trade name extracted by the first extraction unit to extract a trade name similar to the trade name extracted by the first extraction unit. In a case in which the trade name extracted by the third extraction unit is included in the trade name extracted by the second extraction unit, it is determined that the commodity label acquired by the image information acquisition unit is not correct. That is, when the character string “hot curry bun” extracted by the third extraction unit is included in the character string “hot curry bun” extracted by the second extraction unit, the determination unit can determine that the commodity label acquired by the image information acquisition unit is not correct. Due to this, even in a case in which there are a plurality of similar trade names in the storage unit, the accuracy of the determination unit in determining correctness can be improved.

The commodity information inspection system according to one aspect of the present disclosure may further include a notification unit configured to notify that the trade name is extracted by the third extraction unit. With this configuration, it is possible to call an operator's attention to the fact that there is a possibility of the label being incorrect.

A commodity information inspection system according to one aspect of the present disclosure is a commodity information inspection system configured to determine whether a commodity label to be attached to a commodity and/or a wrapping material for wrapping the commodity is correct one corresponding to the commodity, and includes: a storage unit configured to store identification information for identifying the commodity, and commodity information related to the commodity, and to associate the identification information and the commodity information with each other; an identification information specification unit configured to specify the identification information of the commodity related to production; a conversion unit configured to extract, as text information, a predetermined commodity item to be a comparison target in the commodity information that is stored in association with the identification information specified by the identification information specification unit, and convert the extracted text information into first image information; an image information acquisition unit configured to acquire second image information related to the commodity label to be attached to the commodity and/or the wrapping material for wrapping the commodity on which one or more commodity items included in the commodity information are printed; and a determination unit configured to determine whether the commodity label and/or the wrapping material is correct based on a comparison between the first image information converted by the conversion unit and the second image information acquired by the image information acquisition unit.

In the commodity information inspection system having the configuration described above, whether the label is correct is determined by comparing the first image information converted from the commodity item as text information stored in the storage unit with the second image information related to the commodity label to be attached to the commodity and/or the wrapping material for wrapping the commodity instead of comparing the image information of the commodity label to be a sample (to be attached) with the image information of the commodity label to be attached to the commodity acquired by the image information acquisition unit. That is, in the commodity information inspection system having this configuration, the reference data for determining whether the commodity label is correct is the first image information converted from the text information. As a result, even in a case in which the design of the commodity label and/or the wrapping material is changed, the changed portion does not become a comparison target. Due to this, whether the commodity label and/or the wrapping material is correct can be determined without time and effort for work accompanying the change.

In the commodity information inspection system according to one aspect of the present disclosure, the conversion unit may be disposed to be able to optionally set a font at the time when the extracted text information is converted into the first image information. In the commodity information inspection system having this configuration, the font can be selected to match a font of the commodity item printed as label information at the time when the text information is converted into the first image information. Due to this, a comparison between the first image information and the second image information is facilitated, and determination accuracy can be improved.

The commodity information inspection system according to one aspect of the present disclosure further includes an imaging unit configured to image the identification information and the commodity label and/or the wrapping material, wherein the identification information specification unit and the image information acquisition unit may acquire the identification information and the image information from a taken image acquired by the imaging unit. With this configuration, the identification information and the image information can be easily acquired.

In the commodity information inspection system according to one aspect of the present disclosure, the imaging unit may image a register on which the identification information is printed and the commodity label and/or the wrapping material is attached. With this configuration, it is possible to determine whether the commodity label is correct at a site where the commodity label is inspected by using the register.

A control method for a computer according to one aspect of the present disclosure is a control method for a computer used for a commodity information inspection system, in which the commodity information inspection system includes a storage unit configured to store identification information for identifying a commodity, and commodity information related to the commodity, and to associate the identification information and the commodity information with each other, and is configured to determine whether a commodity label to be attached to the commodity and/or a wrapping material for wrapping the commodity is correct one corresponding to the commodity, the control method for a computer includes: an identification information specification step for specifying the identification information of the commodity related to production; an image information acquisition step for acquiring image information related to the commodity label and/or the wrapping material on which one or more commodity items included in the commodity information are printed; a first extraction step for extracting, as text information from the storage unit, a predetermined commodity item to be a comparison target in the commodity information that is stored in association with the identification information specified by the identification information specification step; a second extraction step for extracting, as text information, information of characters included in the image information acquired by the image information acquisition step; and a determination step for determining whether the commodity label and/or the wrapping material is correct based on a comparison between a character string as text information extracted by the first extraction step and a character string as text information extracted by the second extracting step.

In the control method for a computer, whether the commodity label is correct is determined by comparing the commodity item as text information stored in the storage unit with the commodity item as text information extracted from the image information of the commodity label to be attached to the commodity instead of comparing the image information of the commodity label to be a sample (to be attached) with the image information of the commodity label to be attached to the commodity acquired by the image information acquisition unit. That is, in the control method for a computer, the reference data for determining whether the commodity label is correct is not image information but text information. As a result, even in a case in which the design of the commodity label and/or the wrapping material is changed, whether the commodity label and/or the wrapping material is correct can be determined without time and effort for work accompanying the change.

A control method for a computer according to one aspect of the present disclosure is a control method for a computer used for the commodity information inspection system, the commodity information inspection system including the storage unit configured to store the identification information for identifying the commodity, and the commodity information related to the commodity, and to store the identification information and the commodity information with each other, and is configured to determine whether the commodity label to be attached to the commodity and/or the wrapping material for wrapping the commodity is correct one corresponding to the commodity, and the control method includes: an identification information specification step for specifying the identification information of the commodity related to production; an image information acquisition step for acquiring second image information related to the commodity label to be attached to the commodity and/or the wrapping material for wrapping the commodity on which one or more commodity items included in the commodity information are printed; a conversion step for extracting, as text information, a predetermined commodity item to be a comparison target in the commodity information stored in association with the identification information specified by the identification information specification step, and converting the extracted text information into first image information; and a determination step for determining whether the commodity label and/or the wrapping material is correct based on a comparison between the first image information converted by the conversion step and the second image information acquired by the image information acquisition step.

In the control method for a computer described above, whether the commodity label and/or the wrapping material is correct is determined by comparing the first image information converted from the commodity item as text information with the second image information as image information of the commodity label to be attached to the commodity and/or the wrapping material instead of simply comparing the image information of the commodity label to be a sample (to be attached) with the image information of the commodity label to be attached to the commodity and/or the wrapping material acquired by the image information acquisition unit. That is, in this control method for a computer, reference data for determining whether the commodity label and/or the wrapping material is correct is the first image information converted from the text information stored in the storage unit. As a result, even in a case in which the design of the commodity label and/or the wrapping material is changed, the changed portion does not become a comparison target. Due to this, whether the commodity label and/or the wrapping material is correct can be determined without time and effort for work accompanying the change.

According to one aspect of the present disclosure, even in a case in which the design of the commodity label and/or the wrapping material is changed, whether the commodity label and/or the wrapping material is correct can be determined without time and effort for work accompany the change.

### BRIEF DESCRIPTION OF THE DRAWINGS

FIG. 1 is a block diagram illustrating a functional configuration of a commodity information inspection system according to an embodiment.

FIG. 2 is a perspective view of a terminal device constituting the commodity information inspection system illustrated in FIG. 1.

FIG. 3 is a diagram illustrating an example of a label register.

FIG. 4 is a flowchart illustrating a procedure of inspection processing performed by the commodity information inspection system illustrated in FIG. 1.

FIG. 5 is a diagram illustrating an example of image information taken by an imaging unit of the terminal device illustrated in FIG. 2.

FIG. 6 is a diagram illustrating an example of image information taken by the imaging unit of the terminal device illustrated in FIG. 2.

FIG. 7 is a diagram illustrating an example of image information taken by the imaging unit of the terminal device illustrated in FIG. 2.

FIG. 8 is a flowchart illustrating matching determination for a trade name performed by the commodity information inspection system illustrated in FIG. 1.

FIG. 9 is a diagram illustrating a functional configuration of a commodity information inspection system according to a first modification.

FIG. 10 is a diagram illustrating an example of a modification of the label register.

### DETAILED DESCRIPTION

The following describes preferred embodiments according to one aspect of the present disclosure in detail with reference to the attached drawings. Throughout description of the drawings, the same or equivalent component is denoted by the same reference numeral, and redundant description will not be repeated.

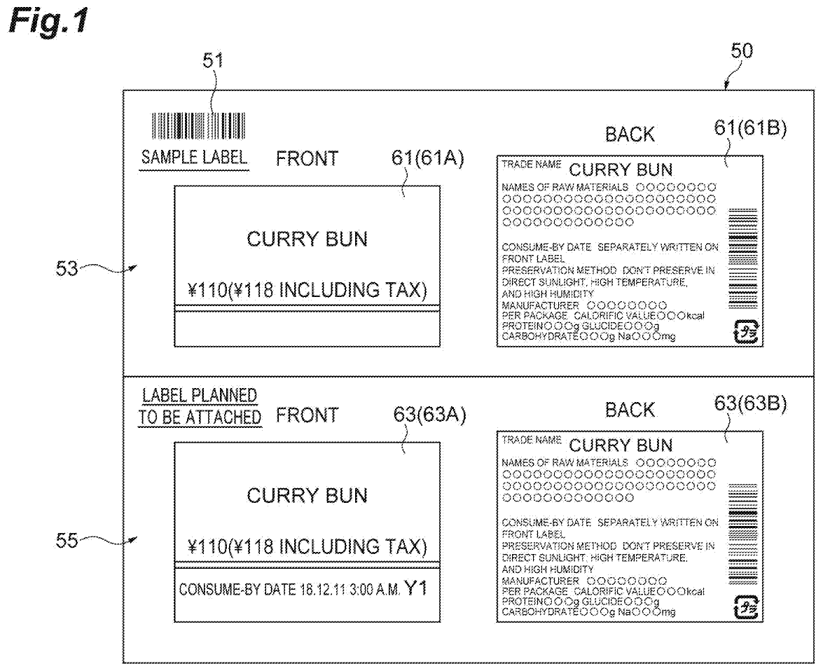

In factories and the like for producing a commodity, as illustrated in FIG. 1, there is provided a label register 50 including a bar code 51 as a portion on which commodity identification information (identification information) for identifying the commodity is printed, a portion 53 to which a correct commodity label 61 (hereinafter, referred to as a “sample label 61”) that should be attached to the commodity is attached, and a portion 55 to which a commodity label 63 that is planned to be attached to the commodity (hereinafter, referred to as a “label 63 planned to be attached”) is attached. An administrator of factories and the like attaches the sample label 61 and the label 63 planned to be attached to the label register 50 as illustrated in FIG. 1, and checks whether the label 63 planned to be attached is a correct label that should be attached. A commodity information inspection system 1 according to an embodiment is a system configured to determine whether the label 63 planned to be attached is correct.

The bar code 51 includes the commodity identification information for identifying the commodity. The commodity identification information is, for example, a code obtained by combining numerals, alphabets, symbols, and the like. In the present embodiment, the bar code 51 includes manufacture identification information as information for specifying a plan for manufacturing the commodity in addition to the commodity identification information. Similarly to the commodity identification information, the manufacture identification information is also a code obtained by combining numerals, alphabets, symbols, and the like, for example. Herein, the bar code is exemplified as information including the commodity identification information and the manufacture identification information. Alternatively, the information may be a two-dimensional code such as a QR code (registered trademark), or information such as a character string.

The sample label 61 includes a front label 61A on which a trade name is written, and a back label 61B on which the trade name, names of raw materials, a consume-by date, a preservation method, a manufacturer, and the like are written. The label 63 planned to be attached includes a front label 63A on which the trade name, the consume-by date, a shipping number, and the like are written, and a back label 63B on which the trade name, the names of raw materials, the consume-by date, the preservation method, the manufacturer, and the like are written. On the front label 61A, character information for calling customer's attention (for sales promotion) may be printed such as “Please eat by the consume-by date” or “seasonal ingredients”.

### First Embodiment

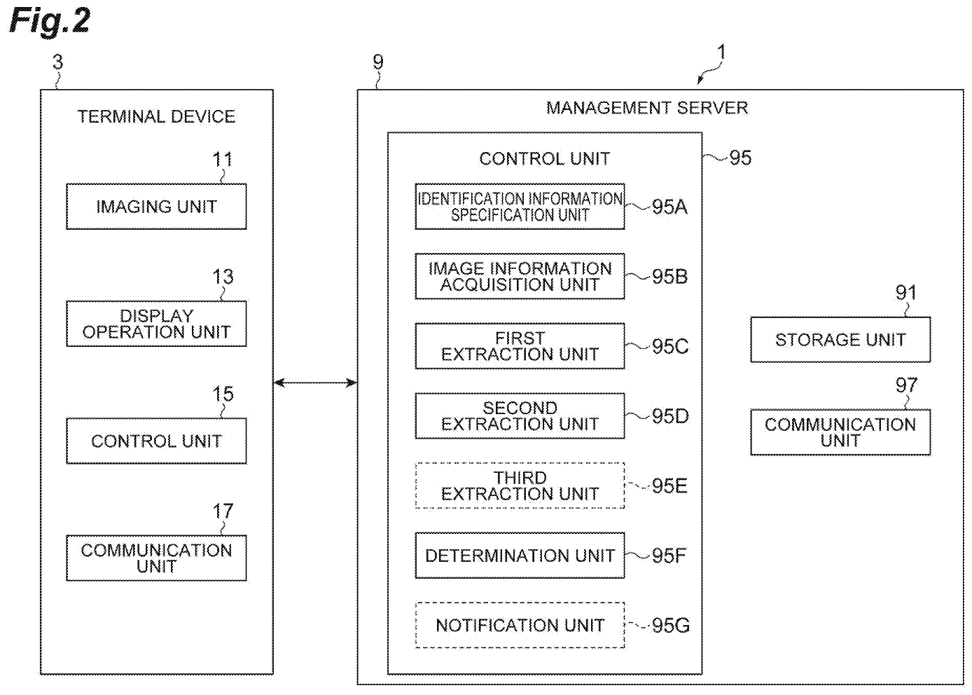

The following describes the commodity information inspection system 1 according to a first embodiment. As illustrated in FIG. 2, the commodity information inspection system 1 includes a terminal device 3, and a management server 9 that is configured to be able to communicate with the terminal device 3.

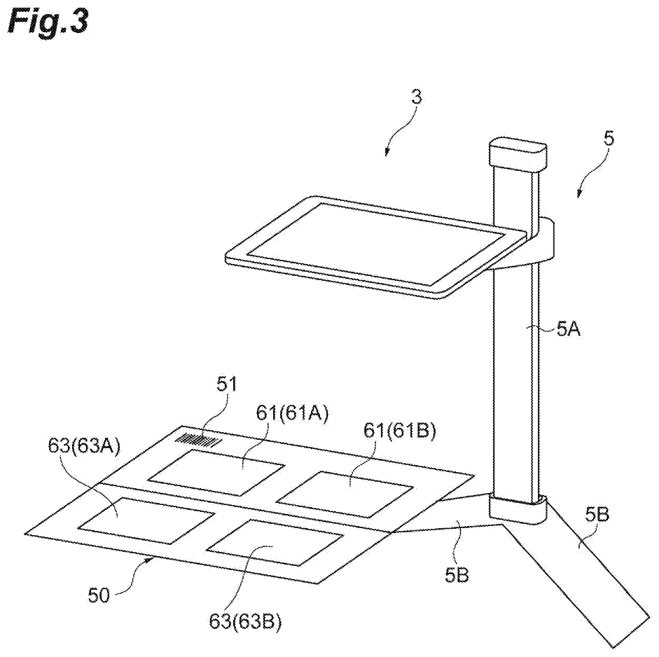

The terminal device 3 is a device configured to transmit a taken image (image information) of the label register 50 to the management server 9, and receive a result of determining whether the label 63 planned to be attached is a correct label from the management server 9. Examples of the terminal device 3 include a desktop terminal, a portable terminal such as a smartphone, and a tablet terminal. For example, as illustrated in FIG. 3, the terminal device 3 images the label register 50 (refer to FIG. 1) in a state of being supported by a stand 5 including a columnar part 5A and leg parts 5B. As illustrated in FIG. 2, the terminal device 3 includes an imaging unit 11, a display operation unit 13, a control unit 15, and a communication unit 17.

The imaging unit 11 is, for example, a camera mounted on a back surface of a tablet terminal. The label register 50 may be imaged by the imaging unit 11 when an operator operates the display operation unit 13, or when the imaging unit 11 is controlled by the management server 9. The imaging unit 11 images the label register 50 on which the bar code 51 is printed and the label 63 planned to be attached is attached as illustrated in FIG. 1. The display operation unit 13 is, for example, a touch panel.

The control unit 15 is an electronic control unit including a central processing unit (CPU), a read only memory (ROM), and a random access memory (RAM). The control unit 15 controls various operations of the terminal device 3. For example, the control unit 15 controls the imaging unit 11 in accordance with operation content of the display operation unit 13 to acquire the taken image of the label register 50, controls the communication unit 17 to transmit the taken image acquired by the imaging unit 11 to the management server 9, and controls the display operation unit 13 to display a result of determining whether the label 63 planned to be attached is correct transmitted from the management server 9. The communication unit 17 exchanges information with the management server 9, transmits the taken image of the label register 50 imaged by the imaging unit 11 to the management server 9, and receives the result of determining whether the label 63 planned to be attached is correct obtained by the management server 9.

The management server 9 is configured as a computer system including a CPU, a main storage unit such as a RAM and a ROM, and an auxiliary storage unit exemplified as a hard disk, a flash memory, and the like. Examples of the management server 9 include a desktop terminal, a portable terminal such as a smartphone, a tablet terminal, and the like. The management server 9 includes a storage unit 91, a control unit 95, and a communication unit 97.

As the storage unit 91, for example, a hard disk, a flash memory, and the like are exemplified as described above. In the storage unit 91, the commodity identification information and commodity information related to the commodity are stored in association with each other. Examples of commodity items of the commodity information related to the commodity include a trade name, a price, a price including tax, and names of raw materials. In the storage unit 91, the manufacture identification information and manufacture information as information related to a plan for manufacturing the commodity are stored in association with each other. Examples of the manufacture information include a consume-by date, a manufacturer, a contact address of a manufacturer, a manufacturing site, a manufacturing line, and a shipping number.

The control unit 95 is an electronic control unit including a central processing unit (CPU), a read only memory (ROM), and a random access memory (RAM). The control unit 95 controls various operations of the management server 9. The control unit 95 may be configured as software to be executed by a CPU when a computer program stored in a ROM is loaded into a RAM, for example. The control unit 95 may also be configured as hardware using an electronic circuit and the like. In the control unit 95, an identification information specification unit 95A, an image information acquisition unit 95B, a first extraction unit 95C, a second extraction unit 95D, a third extraction unit 95E, a determination unit 95F, and a notification unit 95G described below are formed when hardware such as a CPU, a RAM, and a ROM cooperates with software such as a computer program.

The identification information specification unit 95A specifies the identification information of the commodity related to production. In the present embodiment, the identification information specification unit 95A specifies the commodity identification information based on the taken image of the label register 50 transmitted from the terminal device 3. More specifically, the identification information specification unit 95A specifies the commodity identification information as text information (a code) based on an image of the bar code 51 included in the taken image.

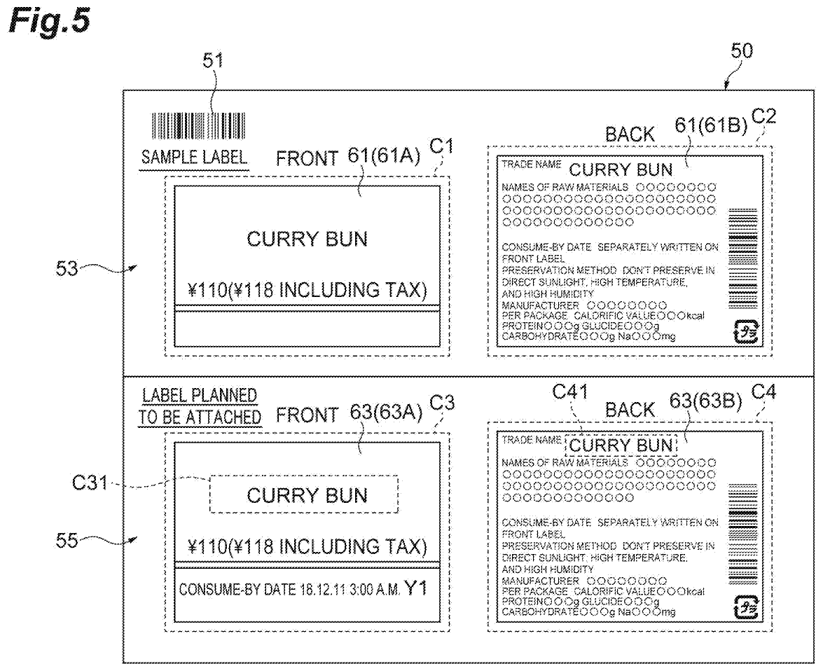

The image information acquisition unit 95B acquires image information related to the label 63 planned to be attached on which one or more commodity items included in the commodity information are printed. In the present embodiment, the image information acquisition unit 95B acquires the image information of the commodity label that is planned to be attached to the commodity from the taken image of the label register 50 transmitted from the terminal device 3. Specifically, as illustrated in FIG. 5, the second extraction unit 95D identifies each of a region C1 to which the front label 61A of the sample label 61 is attached, a region C2 to which the back label 61B of the sample label 61 is attached, a region C3 to which the front label 63A of the label 63 planned to be attached is attached, and a region C4 to which the back label 63B of the label 63 planned to be attached is attached in the taken image of the label register 50. The image information acquisition unit 95B acquires image information present in the region C3 and the region C4 to acquire the image information of the label 63 planned to be attached. The second extraction unit 95D does not necessarily perform the processing of identifying the region C1 and the region C2.

Returning to FIG. 2, the first extraction unit 95C extracts, from the storage unit 91, the commodity information that is stored in association with the commodity identification information specified by the identification information specification unit 95A. In the present embodiment, the first extraction unit 95C extracts, from the storage unit 91, a trade name (commodity item) that is stored in association with the commodity identification information specified by the identification information specification unit 95A.

The second extraction unit 95D extracts, as text information, a character string included in the image information acquired by the image information acquisition unit 95B. More specifically, as illustrated in FIG. 5, the second extraction unit 95D extracts, as a character string, content printed in a region C31 and a region C41 in which the trade name is printed from the image information acquired by the image information acquisition unit 95B. The region C31 and the region C41 are enabled to be identified by the second extraction unit 95D based on coordinate information and the like set in advance. The character string is enabled to be extracted from the image information by using a known optical character recognition (OCR) technique.

As described above, various kinds of information are printed on the front label 61A and the back label 61B. At the time of extracting such information, the second extraction unit 95D cannot necessarily acquire the information to be distinguished for each item. Thus, the second extraction unit 95D may extract information of an item other than a desired item at the same time. For example, at the time of extracting the trade name from the front label 61A, the second extraction unit 95D may extract a character string for calling attention such as “Please eat by the consume-by date”, or a character string such as a price or a consume-by date at the same time.

There may be a case in which the second extraction unit 95D can be adjusted to extract only a desired item by adjusting a position to be extracted by software or hardware to be limited. As described above, for example, as the position to be extracted, the regions C3 and C4 may be extracted based on coordinate information, or may be extracted based on a relative relation and the like with respect to a position of another part. The regions C3 and C4 may be extracted by disposing a mark and the like for fixing an arrangement position of the label register 50 with respect to an installation position of the imaging unit 11 (tablet terminal).

The determination unit 95F determines whether the label 63 planned to be attached is correct based on a degree of matching between a character string as text information extracted by the first extraction unit 95C and a character string as text information extracted by the second extraction unit 95D. Specifically, the determination unit 95F determines that the label 63 planned to be attached that is attached to the label register 50 is correct when the character string extracted by the first extraction unit 95C is included (partially matches) in the character string extracted by the second extraction unit 95D, and determines that the label 63 planned to be attached that is attached to the label register 50 is not correct (incorrect) when the character string extracted by the first extraction unit 95C is not included (does not match) in the character string extracted by the second extraction unit 95D. In this case, partial matching between both character strings is used as a reference for determining whether the label 63 planned to be attached is correct, but exact matching between both character strings may also be used as a reference for determining whether the label 63 planned to be attached is correct.

The communication unit 97 transmits, to the terminal device 3, a result of determining whether the label 63 planned to be attached is correct obtained by the determination unit 95F.

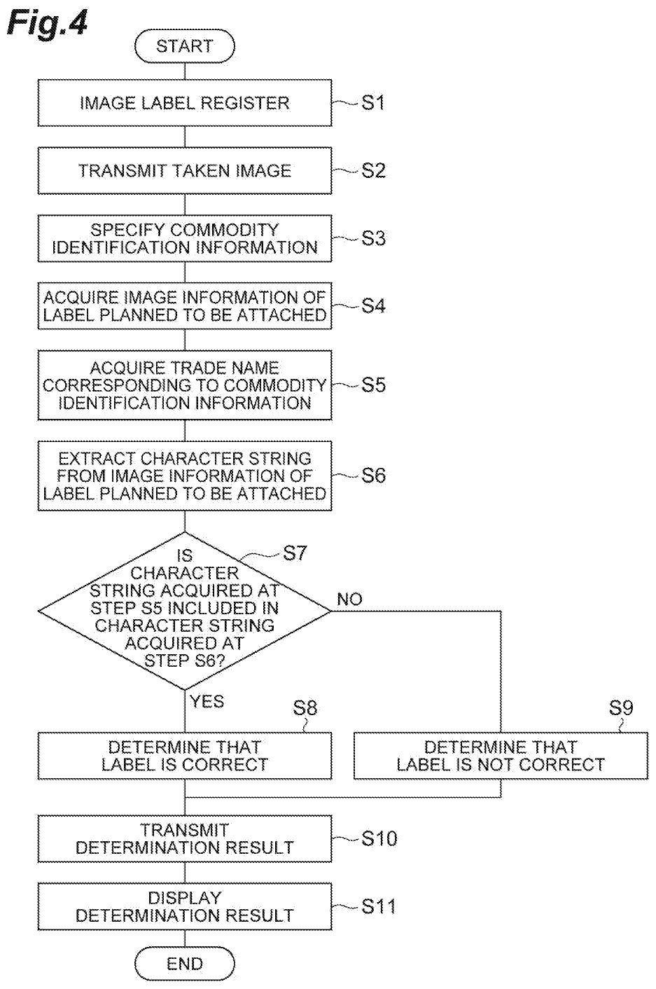

Next, with reference to FIGS. 4 to 6, the following describes an operation of the commodity information inspection system 1. In a case of causing the commodity information inspection system 1 to determine whether the label 63 planned to be attached in the label register 50 is correct, the operator installs the terminal device 3 on the stand 5 (refer to FIG. 3) to enable the label register 50 to be imaged. The operator then operates the display operation unit 13 of the terminal device 3 to cause the imaging unit 11 to image the label register 50. Due to this, the imaging unit 11 acquires a taken image of the label register 50 (Step S1). The taken image of the label register 50 acquired by the imaging unit 11 is transmitted to the management server 9 by the communication unit 17 (Step S2).

The identification information specification unit 95A of the management server 9 specifies the commodity identification information based on a taken image of the bar code 51 included in the taken image of the label register 50 transmitted from the terminal device 3 (Step S3: identification information specification step). The following description will be made assuming that the commodity identification information specified by the identification information specification unit 95A is associated with a trade name “curry bun” in the storage unit 91.

The image information acquisition unit 95B of the management server 9 also acquires image information of the label 63 planned to be attached from the taken image of the label register 50 transmitted from the terminal device 3 (Step S4: image information acquisition step). More specifically, the image information acquisition unit 95B acquires image information present in the region C3 and the region C4 (refer to FIG. 5) to acquire the image information of the label 63 planned to be attached. The following description will be made assuming that the image information acquisition unit 95B acquires images of the front label 63A and the back label 63B as illustrated in FIG. 5, that is, the images of the front label 63A and the back label 63B on which the trade name “curry bun” is printed.

Next, the first extraction unit 95C of the management server 9 extracts, as text information from the storage unit 91, the trade name that is stored in association with the commodity identification information specified by the identification information specification unit 95A (Step S5: first extraction step). In this case, the first extraction unit 95C is assumed to extract the trade name “curry bun” that is stored in association with the commodity identification information in the storage unit 91. Next, the second extraction unit 95D of the management server 9 extracts a character string included in the image information of the front label 63A and the back label 63B acquired by the image information acquisition unit 95B (Step S6: second extraction step). In this case, the second extraction unit 95D is assumed to extract a character string “curry bun ¥110 (¥118 including tax)” including “curry bun” as text information.

Next, the determination unit 95F of the management server 9 determines whether the character string acquired at Step S5 is included in the character string acquired at Step S6 (Step S7). The determination unit 95F determines that the label 63 planned to be attached is correct in a case in which the character string acquired at Step S5 is included in the character string acquired at Step S6 (Step S8: determination step), and determines that the label 63 planned to be attached is not correct in a case in which the character string acquired at Step S5 is not included in the character string acquired at Step S6 (Step S9: determination step). In this case, “included in the character string” means the fact that one of the character strings is segmented into words by morphological analysis and the like, and each of the words is included in the other character string. At the time of extracting the character string as text information by the second extraction unit 95D, erroneous recognition of a character may be caused. Due to this, mismatching of several characters (for example, a predetermined number of characters such as one or two characters) may be allowed.

In this case, the character string “curry bun” acquired at Step S5 is included in the character string “curry bun ¥100 (¥118 including tax)” acquired at Step S6, so that it is determined that the label 63 planned to be attached is correct. The determination unit 95F determines whether each of the front label 63A and the back label 63B is a correct label.

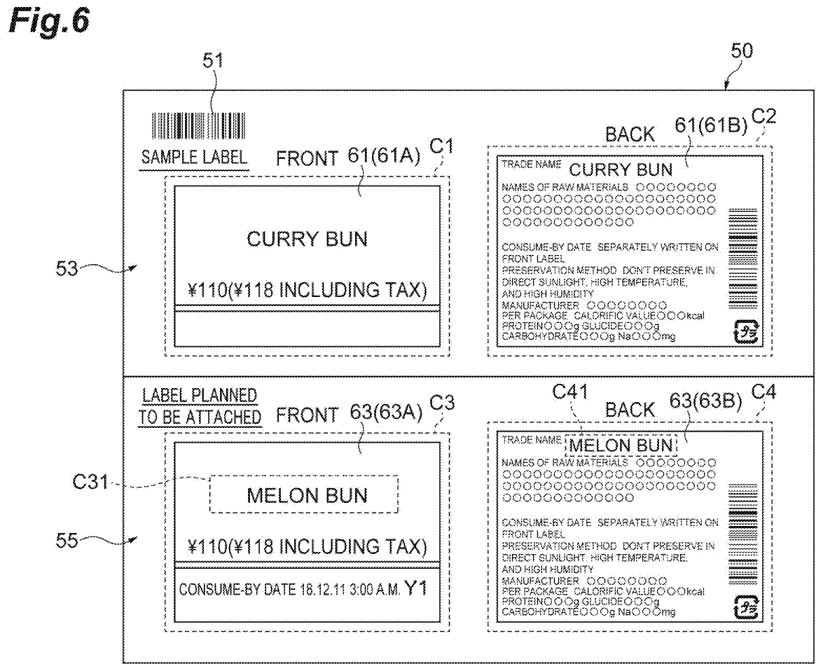

For example, in a case in which the label register 50 as illustrated in FIG. 6 is imaged by the imaging unit 11, the character string “curry bun” acquired at Step S5 is not included in the character string “melon bun ¥110 (¥118 including tax)” acquired at Step S6. Due to this, the determination unit 95F determines that the label 63 planned to be attached is not correct.

Next, the communication unit 97 of the management server 9 transmits a determination result at Step S8 and Step S9 to the terminal device 3 (Step S10). The determination result transmitted from the management server 9 is received by the communication unit 17 of the terminal device 3. The control unit 15 of the terminal device 3 causes the display operation unit 13 to display the received determination result (Step S11).

The commodity information inspection system 1 according to the embodiment described above determines whether the label 63 planned to be attached is correct by comparing the trade name as the character string (text information) stored in the storage unit 91 with the trade name as the character string (text information) extracted from the image information of the label 63 planned to be attached instead of comparing the image information of the sample label 61 with the image information of the label 63 planned to be attached. That is, the commodity information inspection system 1 according to the embodiment described above uses the character string (text information) instead of the image information as the reference data for determining whether the label 63 planned to be attached is correct. As a result, even in a case in which design of the commodity label is changed, it is possible to determine whether the label 63 planned to be attached is correct without performing changing work such as replacing the commodity label to be attached.

In the commodity information inspection system 1 according to the embodiment described above, the imaging unit 11 images the label register 50 on which the bar code 51 is printed and the label 63 planned to be attached is attached. Due to this, whether the label 63 planned to be attached is correct can be determined at a site where whether the label 63 planned to be attached is correct is inspected by using the label register 50.

### Second Embodiment

Next, the following describes the commodity information inspection system 1 according to a second embodiment. The commodity information inspection system 1 according to the second embodiment is different from the commodity information inspection system 1 according to the first embodiment in that the control unit 95 of the management server 9 includes the third extraction unit 95E and the notification unit 95G, and the determination unit 95F performs determination different from the determination in the first embodiment based on a trade name extracted by the third extraction unit 95E from the storage unit 91. The following mainly describes such differences from the first embodiment, and other points will not be described in detail because they are the same as those in the first embodiment.

The third extraction unit 95E extracts, from the storage unit 91, a trade name including the entire character string included in the trade name extracted by the first extraction unit 95C. The trade name extracted from the storage unit 91 in this way is associated with other commodity identification information. For example, in a case in which the character string included in the trade name extracted by the first extraction unit 95C is “curry bun”, and “hot curry bun” and “fiery hot curry bun” are stored in the storage unit 91 as trade names, the third extraction unit 95E extracts “hot curry bun” and “fiery hot curry bun” from the storage unit 91.

Instead of extracting, from the storage unit 91, the trade name including the entire character string included in the trade name extracted by the first extraction unit 95C, the third extraction unit 95E may extract, from the storage unit 91, a trade name including a character string having an edit distance equal to or smaller than a predetermined distance (for example, two times) with respect to the character string of the trade name extracted by the first extraction unit 95C. Also in this case, the third extraction unit 95E can extract another trade name similar to the trade name extracted by the first extraction unit 95C.

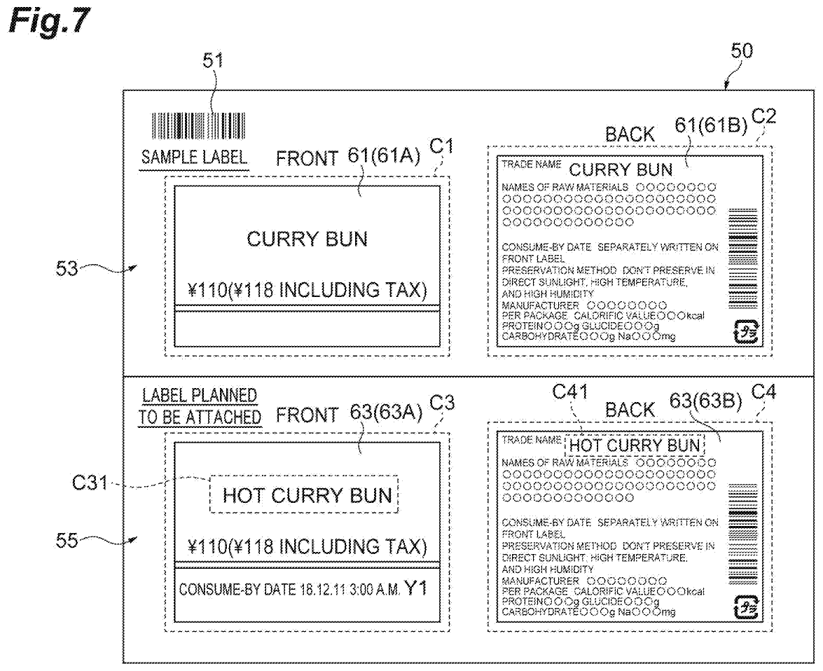

In a case in which the character string of the trade name extracted by the third extraction unit 95E is included in the character string of the trade name extracted by the second extraction unit 95D in addition to the determination in the first embodiment described above, the determination unit 95F determines that the label 63 planned to be attached is not correct. For example, when the label register 50 as illustrated in FIG. 7 is imaged by the imaging unit 11, the first extraction unit 95C extracts the character string “curry bun” of the trade name from the storage unit 91 based on the bar code 51, and the second extraction unit 95D extracts the character string “hot curry bun ¥110 (¥118 including tax)” of the trade name. As described in the first embodiment, the determination unit 95F temporarily determines that the label 63 planned to be attached is correct because the character string “curry bun” acquired at Step S5 is included in the character string “hot curry bun ¥110 (¥118 including tax)” acquired at Step S6. However, the character string “hot curry bun ¥110 (¥118 including tax)” of the trade name extracted by the second extraction unit 95D is also included in the character string “hot curry bun” of the trade name extracted by the third extraction unit 95E, so that the determination unit 95F finally determines that the label 63 planned to be attached is not correct.

The notification unit 95G notifies that the trade name is extracted by the third extraction unit 95E. Specifically, in a case in which the trade name is extracted by the third extraction unit 95E, the notification unit 95G causes the display operation unit 13 of the terminal device 3 to display the fact that the trade name similar to the trade name extracted by the first extraction unit 95C is present in the storage unit 91. The notification unit 95G may also display a specific trade name extracted by the third extraction unit 95E.

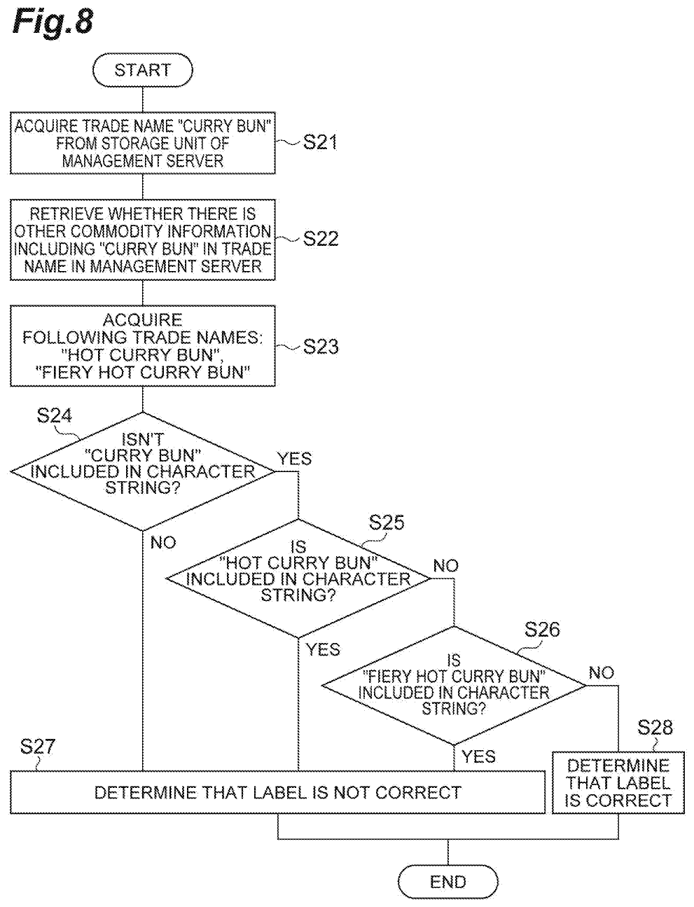

The following describes details of a determination method performed by the determination unit 95F according to the second embodiment with reference to FIG. 8. Similarly to the first embodiment, the first extraction unit 95C extracts, from the storage unit 91, the trade name that is stored in association with the commodity identification information specified by the identification information specification unit 95A. In this case, the first extraction unit 95C is assumed to acquire the trade name “curry bun” from the storage unit 91 (Step S21).

Next, the third extraction unit 95E retrieves whether there is another trade name including “curry bun” extracted by the first extraction unit 95C in the storage unit 91 (Step S22). In this case, the third extraction unit 95E is assumed to extract the trade names “hot curry bun” and “fiery hot curry bun” from the storage unit 91 (Step S23). Next, the determination unit 95F determines whether “curry bun” is included in the character string of the trade name extracted by the second extraction unit 95D (Step S24).

If “curry bun” is not included in the character string of the trade name (NO at Step S24), the determination unit 95F determines that the label 63 planned to be attached is not correct (incorrect) (Step S27). On the other hand, if “curry bun” is included in the character string of the trade name (YES at Step S24), the determination unit 95F determines whether “hot curry bun” is included in the character string of the trade name extracted by the second extraction unit 95D (Step S25).

If “hot curry bun” is included in the character string of the trade name (YES at Step S25), the determination unit 95F determines that the label 63 planned to be attached is not correct (incorrect) (Step S27). On the other hand, if “hot curry bun” is not included in the character string of the trade name (NO at Step S25), the determination unit 95F determines whether “fiery hot curry bun” is included in the character string of the trade name extracted by the second extraction unit 95D (Step S26).

If “fiery hot curry bun” is included in the character string of the trade name (YES at Step S26), the determination unit 95F determines that the label 63 planned to be attached is not correct (incorrect) (Step S27). On the other hand, if “fiery hot curry bun” is not included in the character string of the trade name (NO at Step S26), the determination unit 95F determines that the label 63 planned to be attached is correct (not incorrect) (Step S28).

In the determination processing performed by the determination unit 95F according to the second embodiment, Step S25 and Step S26 can be replaced with each other. In the processing, Step S25 and Step S26 may be performed before Step S24.

In a case in which there is another trade name including an attributive word and the entire character string of itself like “hot curry bun” or “fiery hot curry bun” with respect to “curry bun”, and a trade name including a larger number of attributive words is included in the character string extracted by the second extraction unit 95D, there is a high probability that the front label 61A (back label 61B) attached to the label register 50 corresponds to the trade name including a larger number of attributive words. Thus, in a case in which the character string extracted by the second extraction unit 95D includes a trade name longer than the trade name including itself extracted by the third extraction unit 95E, the commodity having the trade name extracted by the third extraction unit 95E may be determined to match the front label 61A (back label 61B) attached to the label register 50 (the procedure may be ended).

The following describes determination processing according to the first embodiment in a case in which there are “curry bun”, “hot curry bun”, and “fiery hot curry bun” as the trade names stored in the storage unit 91, the character string acquired by the first extraction unit 95C is “curry bun”, and the character string acquired by the second extraction unit 95D is “hot curry bun” as described above. In this case, “curry bun” is included in the character string acquired by the second extraction unit 95D, so that the determination unit 95F according to the first embodiment determines that the label 63 planned to be attached on which “hot curry bun” is printed that is acquired by the image information acquisition unit 95B is a correct commodity label. In this way, determination accuracy may be lowered depending on a type of the trade name stored in the storage unit 91 in the first embodiment.

On the other hand, in the commodity information inspection system 1 according to the second embodiment, the third extraction unit 95E extracts the trade name similar to the trade name extracted by the first extraction unit 95C, and in a case in which the character string of the trade name extracted by the third extraction unit 95E is included in the character string of the trade name extracted by the second extraction unit 95D, the determination unit 95F determines that the label 63 planned to be attached is not correct. That is, the determination unit 95F determines whether the character string “hot curry bun” or “fiery hot curry bun” extracted by the third extraction unit 95E is included in the character string “hot curry bun” extracted by the second extraction unit 95D. In this case, the determination unit 95F determines that the character string “hot curry bun” extracted by the third extraction unit 95E is included in the character string “hot curry bun” extracted by the second extraction unit 95D, so that it is determined that the label 63 planned to be attached that is acquired by the image information acquisition unit 95B is not correct. Due to this, it is possible to improve accuracy in determining correctness by the determination unit 95F.

The embodiments have been described above, but an aspect of the present disclosure is not limited to the embodiments described above. The embodiments can be variously modified without departing from the gist of the present invention.

First Modification

Regarding the commodity information inspection system 1 according to the first embodiment and the second embodiment described above, exemplified is the determination unit 95F configured to determine whether the label 63 planned to be attached is correct by comparing the trade name as text information stored in the storage unit 91 with the trade name as text information extracted from the image information of the label 63 planned to be attached, but determination performed by the determination unit 95F is not limited thereto.

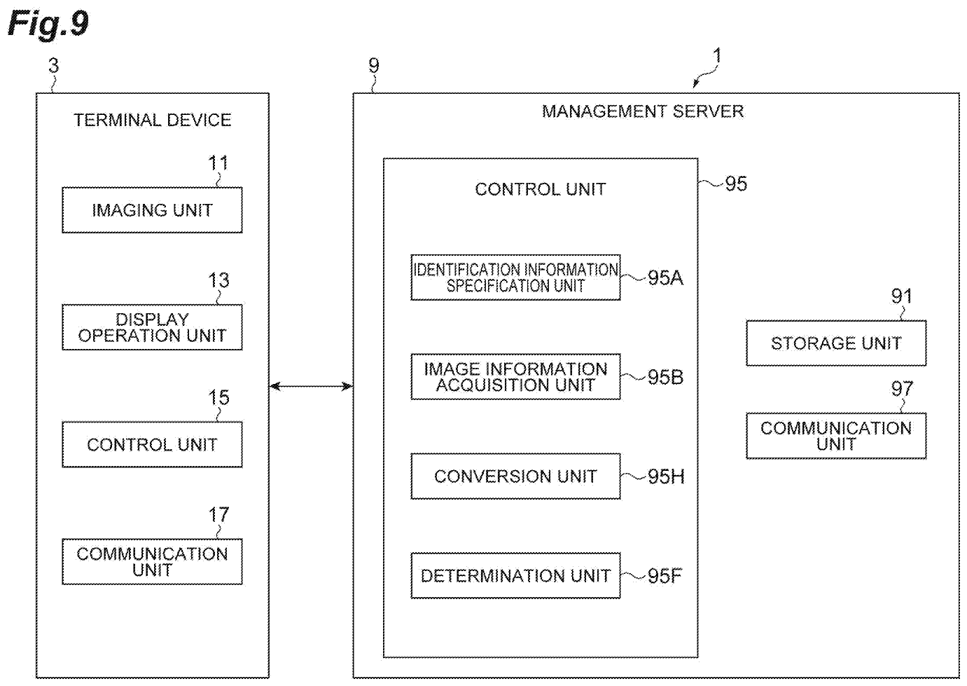

As illustrated in FIG. 9, in the control unit 95 of the commodity information inspection system 1 according to a first modification, hardware such as a CPU, a RAM, and a ROM cooperates with software such as a computer program to faun the identification information specification unit 95A, the image information acquisition unit 95B, a conversion unit 95H, and the determination unit 95F described below. The following describes the conversion unit 9511 and the determination unit 95F having a function different from that of the configuration in the embodiments described above in detail.

The conversion unit 95H extracts, as text information, a trade name (predetermined commodity item) to be a comparison target in the commodity information that is stored in association with the identification information specified by the identification information specification unit 95A, and converts the extracted text information into first image information (conversion step). The conversion unit 95H may be disposed to be able to optionally set a font at the time of converting the extracted text information into the first image information. For example, the conversion unit 95H may select a font of a character included in second image information as the image information of the label 63 planned to be attached acquired by the image information acquisition unit 95B. The selection performed by the conversion unit 95H may be performed such that the font may be automatically converted into a font obtained by analyzing the image information of the label 63 planned to be attached, or the font may be selected by an operation performed by the operator.

The font into which text information should be converted (a typeface, a size, character spacing, an arrangement position of a character, and the like) is, for example, stored in the storage unit 91 of the management server 9 together with corresponding commodity identification information. The conversion unit 95H acquires the font into which text information should be converted from the management server 9 in accordance with the commodity identification information corresponding to the bar code 51 read from a label register 50A, and converts the text information into the font. Alternatively, the conversion unit 95H may acquire the font into which text information should be converted from a printer that has printed characters on the label.

The determination unit 95F determines whether the label 63 planned to be attached is correct based on a comparison between the first image information converted by the conversion unit 95H and the second image information acquired by the image information acquisition unit 95B. Specifically, the determination unit 95F determines whether the label 63 planned to be attached is correct based on a degree of matching between the first image information and the second image information. The determination based on the degree of matching described herein can be performed, for example, by using a known comparison method such as determination based on a degree of matching of image information, determination based on a degree of matching of a characteristic part of image information, and the like. Specifically, for example, the determination unit 95F may determine whether the label 63 planned to be attached is correct based on whether a characteristic portion of an image included in the first image information including a converted character is included in a characteristic portion of an image included in the second image information. The second image information includes information other than character information of an item to be a comparison target, so that it is preferable to perform determination depending on whether the characteristic portion of the image included in the first image information is included in the characteristic portion of the image included in the second image information. The image information (the first image information and the second image information) described herein indicates image data having a format of JPEG, GIF, PNG TIFF, BMP, PDF, or the like. As illustrated in FIG. 5, the image information acquisition unit 95B may cut out a character string portion by identifying the region C3 and the region C4.

The commodity information inspection system 1 according to the first modification determines whether the label 63 planned to be attached is correct by comparing the first image information that is created based on the trade name stored as text information in the storage unit 91 with the second image information as the image information of the label 63 planned to be attached instead of simply comparing the image information of the sample label 61 with the image information of the label 63 planned to be attached that is acquired by the image information acquisition unit 95B. That is, in the commodity information inspection system 1 according to the first modification, the reference data for determining whether the label 63 planned to be attached is correct is the first image information that is generated based on the text information stored in the storage unit 91. As a result, even in a case in which the design of the label planned to be attached is changed, it is possible to determine whether the label 63 planned to be attached is correct without performing changing work such as replacing the sample label.

Additionally, the commodity information inspection system 1 according to the first modification can select the font to be matched with the font of the commodity item printed as the label information at the time of converting the text information into the first image information, so that the comparison between the first image information and the second image information is facilitated, and determination accuracy can be improved. Specifically, this configuration is effective for a case in which the second image information includes a character printed in a special font.

Second Modification

In the embodiments and the modification described above, exemplified is a case in which “trade name” is extracted as the commodity item extracted by the first extraction unit 95C and as the commodity item extracted by the second extraction unit 95D, but the embodiments and the modification are not limited thereto. For example, any one of or a plurality of commodity items such as a price, a price including tax, names of raw materials, a consume-by date, a manufacturer, a contact address of a manufacturer, a manufacturing site, a manufacturing line, and a shipping number may be extracted in place of or in addition to the trade name extracted by the first extraction unit 95C and the second extraction unit 95D. Also in this case, it is possible to determine whether the label 63 planned to be attached is correct.

Third Modification

In the embodiments and the modifications described above, as illustrated in FIG. 1, exemplified is a case in which whether the label 63 planned to be attached is correct is determined by using the label register 50 to which the sample label 61 and the label 63 planned to be attached are attached, but the embodiments and the modifications are not limited thereto. For example, whether the label 63 planned to be attached is correct may be determined for the label 63 planned to be attached that is attached to a label register including no attachment region for the sample label 61, the label register on which only character strings of commodity items that should be checked (a trade name, a price, a consume-by date, a character string related to a bar code, a name of a production plant, an identification code for a production line, an identification code for delivery, and the like) are printed (or attached).

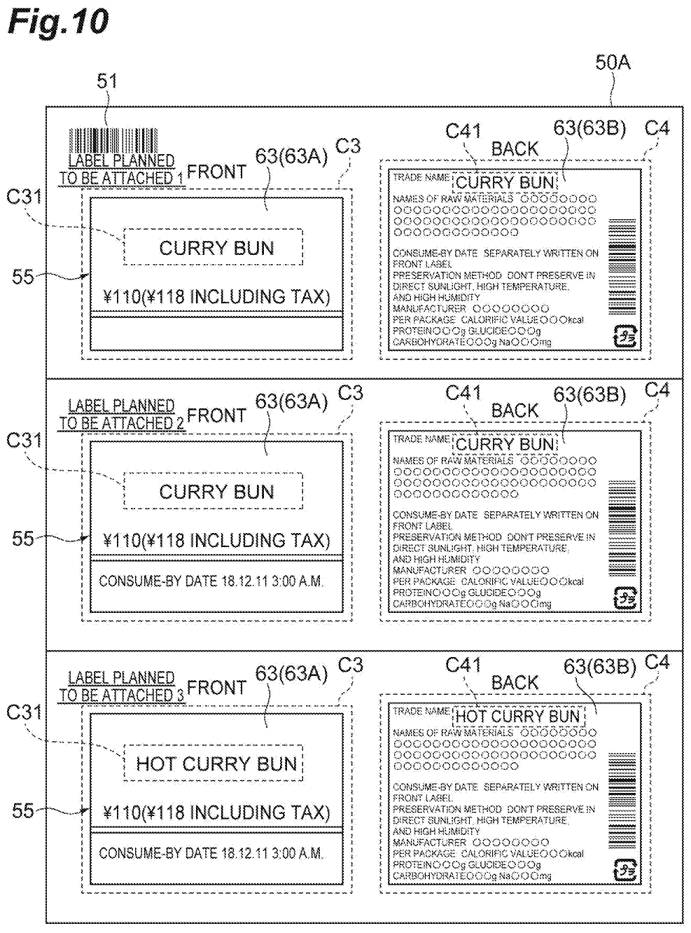

Furthermore, the commodity information inspection system 1 can also determine whether the label 63 planned to be attached is correct for the label 63 planned to be attached that is attached to the label register 50A for managing the label 63 planned to be attached to each of commodities manufactured in a plurality of manufacturing lines as illustrated in FIG. 10. Specifically, the commodity information inspection system 1 determines whether the label 63 planned to be attached is correct for the label 63 planned to be attached that is attached to the label register 50A including the bar code 51 and portions 55 to which three labels 63 planned to be attached are respectively attached (portions to which the labels 63 planned to be attached are attached for respective manufacturing lines).

The bar code 51 of the label register 50A includes three pieces of commodity identification information that are stored in association with the respective three lines. The first extraction unit 95C then extracts each of the trade names respectively associated with the three pieces of commodity identification information from the storage unit 91. In this case, for example, the first extraction unit 95C is assumed to extract the trade names “curry bun”, “curry bun”, and “hot curry bun” from the storage unit 91 based on the bar code 51.

Next, the second extraction unit 95D extracts a character string included in the image information of the label 63 planned to be attached included in a taken image of the label register 50A imaged by the imaging unit 11. In this case, the second extraction unit 95D is assumed to extract the trade names “curry bun”, “curry bun”, and “hot curry bun”. The determination unit 95F determines whether each of the labels 63 planned to be attached corresponding to the three lines is correct based on a degree of matching between the character string as text information extracted by the first extraction unit 95C and the character string as text information extracted by the second extraction unit 95D. Also in this case, similarly to the embodiments and the modifications described above, whether the label 63 planned to be attached is correct can be determined.

Fourth Modification

In the embodiments and the modifications described above, the determination unit 95F directly uses, as a comparison target (a target for determining the degree of matching), the character string of the trade name (commodity item) that is stored in the storage unit 91 and extracted by the first extraction unit 95C, but the embodiments and the modifications are not limited thereto. For example, the first extraction unit 95C may delete a specific character set in advance from the character string of the trade name stored in the storage unit 91, and the determination unit 95F may use the character string from which the specific character is deleted as the comparison target. Examples of the specific character include character strings such as “seasoned”, “Kansai-style”, and “Kanto-style”.

This is because, for example, a character string for management (for example, Kansai-style or Kanto-style) that is not printed on a package (a label or wrapping material) may be given to characters extracted by the first extraction unit 95C to manage commodities including a seasoning or composition that is different depending on a delivery area. Characters of “seasoned” may be printed in advance on a portion corresponding to a surface of a film (wrapping material) in which layer for rice balls is enclosed to distinguish seasoned layer from normal laver. This is because the trade name from which the character string of “seasoned” is omitted is printed on the front label 61A to avoid overlap description, so that the trade name not including the character string “seasoned” is obtained from the character string of the label 63 planned to be attached that is attached to the label register 50 to be extracted by the second extraction unit 95D.

### OTHER MODIFICATIONS

In the embodiments and the modifications described above, exemplified is a system configured to determine whether the commodity label to be attached to the commodity (label 63 planned to be attached) is correct, but the system may be configured to determine whether the wrapping material for wrapping the commodity is correct. The wrapping material may also be attached to the register (with adhesive tape and the like) to be managed. Similarly to the label, various commodity items such as a trade name are printed on the wrapping material.

In the embodiments and the modifications described above, exemplified is a case of causing the determination unit 95F to determine whether the label 63 planned to be attached is correct by imaging the label 63 planned to be attached that is attached to the label register 50 with the imaging unit 11 of the terminal device 3, but the embodiments and the modifications are not limited thereto. For example, the determination unit 95F may be caused to determine whether the label 63 planned to be attached is correct by imaging the label 63 planned to be attached with the imaging unit 11 of the terminal device 3 after inputting the commodity identification information to the terminal device 3 via the display operation unit 13 or scanning the bar code 51 with a bar code reader, or by reading out the image information (for example, image data having a format of JPEG, GIF, PNC TIFF, BMP, PDF, or the like) of the label 63 planned to be attached that is prepared in advance.

In the embodiments and the modifications described above, exemplified is a case in which the identification information specification unit 95A and the image information acquisition unit 95B are disposed in the terminal device 3, and the storage unit 91, the first extraction unit 95C, the second extraction unit 95D, and the determination unit 95F are disposed in the management server 9. However, the embodiments and the modifications are not limited thereto. For example, the commodity information inspection system 1 may have a configuration in which the storage unit 91, the identification information specification unit 95A, the image information acquisition unit 95B, the first extraction unit 95C, the second extraction unit 95D, and the determination unit 95F are disposed in one terminal device or server device.

In the embodiments and the modifications described above, exemplified is a case in which one aspect of the present disclosure is implemented as the commodity information inspection system 1. Alternatively, one aspect of the present disclosure may be implemented as a control method for a computer or a computer control program for causing a computer to determine whether the label 63 planned to be attached that is acquired by the image information acquisition unit 95B is a label corresponding to the identification information specified by the identification information specification unit 95A.

Exemplified is a case of reading the label planned to be attached (register) by a tablet terminal, but the embodiments and the modifications are not limited thereto. The label 63 planned to be attached or the label register 50 may be read by using a scanner function and the like of a composite machine.

In the embodiments and the modifications described above, determination is made depending on whether the character string extracted by the first extraction unit 95C (or the third extraction unit 95E) is included in the character string extracted by the second extraction unit 95D, but the embodiments and the modifications are not limited thereto. In a case in which only a character string corresponding to an item to be compared is specified and extracted as text based on a relative position of the character string extracted by the second extraction unit 95D with respect to the label or the wrapping material, or by deleting an unnecessary character string such as a price for the trade name from the character string extracted by the second extraction unit 95D, the determination unit 95F may determine correctness based on matching (a degree of matching) between the character string extracted by the second extraction unit 95D and the character string extracted by the first extraction unit 95C (or the third extraction unit 95E).

What is claimed is:

1. A commodity information inspection system configured to determine whether a commodity label to be attached to a commodity and/or a wrapping material for wrapping the commodity is correct one corresponding to the commodity, the commodity information inspection system comprising:
a storage unit configured to store identification information for identifying the commodity, and commodity information related to the commodity, and to associate the identification information and the commodity information with each other;
an identification information specification unit configured to specify identification information of the commodity related to production;
an image information acquisition unit configured to acquire image information related to the commodity label to be attached to the commodity and/or the wrapping material for wrapping the commodity on which one or more commodity items included in the commodity information are printed;
a first extraction unit configured to extract, as text information from the storage unit, a predetermined commodity item to be a comparison target in the commodity information that is stored in association with the identification information that is specified by the identification information specification unit;
a second extraction unit configured to extract, as text information, information of characters included in the image information acquired by the image information acquisition unit; and
a determination unit configured to determine whether the commodity label and/or the wrapping material is correct based on a comparison between a character string as text information extracted by the first extraction unit and a character string as text information extracted by the second extraction unit.

2. The commodity information inspection system according to claim 1, wherein the first extraction unit extracts a trade name as the commodity item.

3. The commodity information inspection system according to claim 2, further comprising a third extraction unit configured to extract, from the storage unit, a trade name that includes the entire character string included in the trade name extracted by the first extraction unit and is associated with other identification information different from the identification information specified by the identification information specification unit, wherein
the determination unit determines that the commodity label and/or the wrapping material is not correct in a case in which the character string of the trade name extracted by the third extraction unit is included in the character string of the trade name extracted by the second extraction unit.

4. The commodity information inspection system according to claim 2, further comprising a third extraction unit configured to extract, from the storage unit, a trade name having an edit distance equal to or smaller than a predetermined value with respect to the character string of the trade name extracted by the first extraction unit, the trade name being associated with other identification information different from the identification information specified by the identification information specification unit, wherein
the determination unit determines that the commodity label and/or the wrapping material is not correct in a case in which the character string of the trade name extracted by the third extraction unit is included in the character string of the trade name extracted by the second extraction unit.

5. The commodity information inspection system according to claim 3, further comprising a notification unit configured to notify that the trade name is extracted by the third extraction unit.

6. The commodity information inspection system according to claim 4, further comprising a notification unit configured to notify that the trade name is extracted by the third extraction unit.

7. A commodity information inspection system configured to determine whether a commodity label to be attached to a commodity and/or a wrapping material for wrapping the commodity is correct one corresponding to the commodity, the commodity information inspection system comprising:
a storage unit configured to store identification information for identifying the commodity, and commodity information related to the commodity, and to associate the identification information and the commodity information with each other;
an identification information specification unit configured to specify the identification information of the commodity related to production;
a conversion unit configured to extract, as text information, a predetermined commodity item to be a comparison target in the commodity information that is stored in association with the identification information specified by the identification information specification unit, and convert the extracted text information into first image information;
an image information acquisition unit configured to acquire second image information related to the commodity label to be attached to the commodity and/or the wrapping material for wrapping the commodity on which one or more commodity items included in the commodity information are printed; and
a determination unit configured to determine whether the commodity label and/or the wrapping material is correct based on a comparison between the first image information converted by the conversion unit and the second image information acquired by the image information acquisition unit.

8. The commodity information inspection system according to claim 7, wherein the conversion unit is configured to be able to optionally set a font at the time when the extracted text information is converted into the first image information.

9. The commodity information inspection system according to claim 1, further comprising an imaging unit configured to image the identification information and the commodity label and/or the wrapping material, wherein
the identification information specification unit and the image information acquisition unit acquire the identification information and the image information from a taken image acquired by the imaging unit.

10. The commodity information inspection system according to claim 7, further comprising an imaging unit configured to image the identification information and the commodity label and/or the wrapping material, wherein
the identification information specification unit and the image information acquisition unit acquire the identification information and the image information from a taken image acquired by the imaging unit.

11. The commodity information inspection system according to claim 9, wherein the imaging unit images a register on which the identification information is printed and the commodity label and/or the wrapping material is attached.

12. The commodity information inspection system according to claim 10, wherein the imaging unit images a register on which the identification information is printed and the commodity label and/or the wrapping material is attached.

13. A control method for a computer used for a commodity information inspection system, wherein the commodity information inspection system includes a storage unit configured to store identification information for identifying a commodity, commodity information related to the commodity, and to associate the identification information and the commodity information with each other, and is configured to determine whether a commodity label to be attached to the commodity and/or a wrapping material for wrapping the commodity is correct one corresponding to the commodity, the control method for a computer causing a computer to execute:
an identification information specification step for specifying the identification information of the commodity related to production;
an image information acquisition step for acquiring image information related to the commodity label and/or the wrapping material on which one or more commodity items included in the commodity information are printed;
a first extraction step for extracting, as text information from the storage unit, a predetermined commodity item to be a comparison target in the commodity information that is stored in association with the identification information specified by the identification information specification step;
a second extraction step for extracting, as text information, information of characters included in the image information acquired by the image information acquisition step; and
a determination step for determining whether the commodity label and/or the wrapping material is correct based on a comparison between a character string as text information extracted by the first extraction step and a character string as text information extracted by the second extracting step.

14. A control method for a computer used for a commodity information inspection system, wherein the commodity information inspection system includes a storage unit configured to store identification information for identifying a commodity, and commodity information related to the commodity, and to store the identification information and the commodity information with each other, and is configured to determine whether a commodity label to be attached to the commodity and/or a wrapping material for wrapping the commodity is correct one corresponding to the commodity, the control method for a computer causing a computer to execute:
an identification information specification step for specifying the identification information of the commodity related to production;
an image information acquisition step for acquiring second image information related to the commodity label to be attached to the commodity and/or the wrapping material for wrapping the commodity on which one or more commodity items included in the commodity information are printed;
a conversion step for extracting, as text information, a predetermined commodity item to be a comparison target in the commodity information stored in association with the identification information specified by the identification information specification step, and converting the extracted text information into first image information; and
a determination step for determining whether the commodity label and/or the wrapping material is correct based on a comparison between the first image information converted by the conversion step and the second image information acquired by the image information acquisition step.
